(19) United States
(12) Patent Application Publication
(10) Pub. No.: US 2005/0233729 A1
(43) Pub. Date: Oct. 20, 2005

(54) Method and control member for controlling access to a radio communication cellular system through a wireless local netwrok

(76) Inventors: Saso Stojanovski, PARIS (FR); David Steer, Ontario (CA); Denis Fauconnier, Saint Remy Les Chevreuses (FR)

Correspondence Address: DLA PIPER RUDNICK GRAY CARY US LLP, P. O. BOX 64807, CHICAGO, IL, 60664-0807, US

(21) Appl. No.: 10/519,976

(22) PCT Filed: Jun. 26, 2003
(86) PCT No.: PCT/FR03/01970

§ 371 Date: Dec. 30, 2004

(30) Foreign Application Priority Data
Jul. 5, 2002 (FR) 02/08481

(51) Int. Cl. H04M 3/16

(52) U.S. Cl. 455/411; 455/410; 455/450

(57) ABSTRACT

The cellular system has a radio access network comprising base stations and a controller to which a wireless local area network is linked. A terminal is authenticated with the cellular system through the radio access network, and in response an authentication token allocated thereto. The allocated token is transmitted from the controller to the terminal through the radio access network. The allocated token and an identifier of the terminal are further transmitted from the controller to an authentication server accessible through said wireless network. The terminal is authenticated with the wireless network by verifying that the terminal possesses the token transmitted to said authentication server.

The present invention relates to techniques for accessing cellular networks from radio terminals. It is more particularly aimed at the control of access to one or more cellular radio communication systems through a wireless local area network.

Wireless local area networks, or WLANs, nowadays allow the users of appropriate terminals to obtain high bit rate access to telecommunication services. It has been proposed that such local area networks be associated with extended cellular systems so as to afford the subscribers to these cellular systems a large bit rate capability in specified zones (“hot spots”).

This kind of association may relate to various types of WLAN and various types of cellular systems. For illustrative purposes and without any limitation being implied, in what follows interest will be focused more particularly on WLANs of IEEE 802.11 type standardized by the IEEE (“Institute of Electrical and Electronics Engineers”), and on third-generation cellular systems of UMTS type (“Universal Mobile Telecommunication System”) standardized by the 3GPP organization (“3^{rd} Generation Partnership Project”).

Most of the current cellular systems, in particular the UMTS systems, comprise on the one hand a core network and on the other hand one or more radio access networks. The core network comprises intermeshed switches, called GSNs (“GPRS Support Nodes”), as well as various servers used in particular for managing the subscribers of the system (HLR, “Home Location Register”). The most common access network of UMTS systems is called UTRAN (“UMTS Terrestrial Radio Access Network”). It is composed of controllers called RNCs (“Radio Network Controllers”) and of base stations called “Nodes B” distributed over the zone of coverage of the access network and each controlled by one of the RNCS.

To associate a WLAN technology with such a cellular system, an integration scheme with weak coupling between the two technologies has been proposed. Typically, a gateway is then provided between the WLAN and an HLR of the core network of the cellular system.

The present invention pertains rather to integration schemes with tight coupling between the two technologies, thereby allowing users of IEEE 802.11 stations to benefit from a large part of the services afforded by the cellular infrastructure.

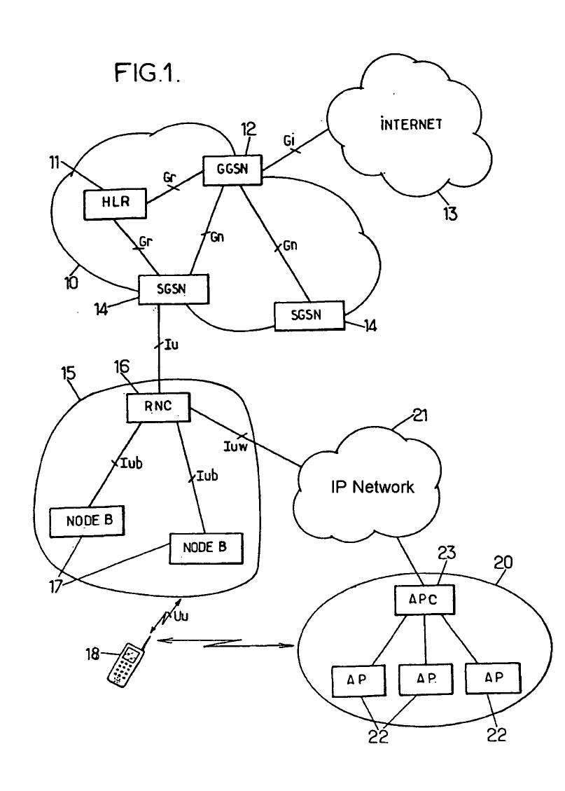

FIG. 1 shows an architecture that can be obtained when such an integration scheme is applied. The switches of the core network 10 communicate with one another through a standardized interface called Gn, and with the HLR 11 through an interface called Gr. We distinguish between GGSNs 12 (“Gateway GSNs”) which serve as gateways with external networks 13 such as the Internet for example, and SGSNs 14 (“Serving GSNS”) which are linked to the UTRAN through an interface called Iu.

UTRAN 15 comprises a certain number of RNCs 16 which are each linked to an SGSN of the core network though the Iu interface (a single RNC is represented in FIG. 1). Each RNC controls one or more nodes B 17 through an interface Iub. The radio interface between a node B 17 and a UMTS terminal 18 (UE, “User Equipment”) is called Uu.

In the integration diagram illustrated by FIG. 1, the RNC 16 is moreover linked to a WLAN 20 through a routed network 21 based on the IP protocol. The WLAN 20 comprises one or more access points 22, called APs in the IEEE terminology. If there are several APs 22, they are typically supervised by a distribution system 23 that can take the form of an access point controller (APC).

A UMTS/IEEE 802.11 dual-mode terminal is capable of communicating by radio with a node B 17 but also with an AP 22.

This tight coupling scheme makes it possible to reuse the UMTS concepts of quality of service, of security and of mobility in respect of users accessing the system through the WLAN 20. It also allows its users to access all the UMTS services, in particular the locating service.

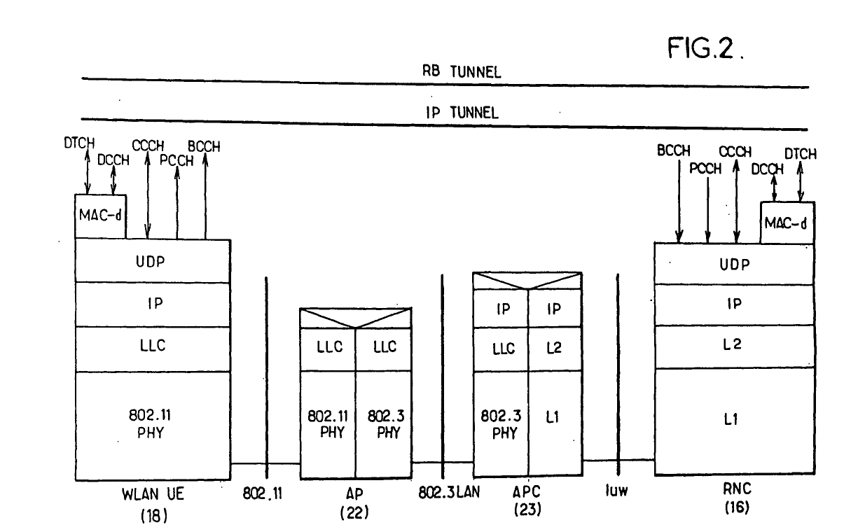

Given the relatively sizeable population of APs of IEEE 802.11 type already installed, it is desirable for the tight coupling scheme to impose a minimum of requirements at the level of these APs. This is the reason why the UMTS protocol stack on the RNC/WLAN interface (here called the Iuw interface) is advantageously constructed on top of the customary UDP/IP stack in WLANs, as is illustrated by FIG. 2.

FIG. 2 shows protocol stacks used for the exchanges between a dual-mode UE 18 and the RNC 16 through the wireless local area network 20. Inside the WLAN 20, the physical layer complies with the IEEE 802.11 specifications regarding the radio interface and, for example, with the IEEE 802.3 specifications regarding the wire interface between the AP 22 and the APC 23. The link layer protocol is LLC, as specified in the IEEE 802.2 standard. FIG. 2 also shows the IP protocol layer used to route the information between the RNC 16 and the terminal 18 through the WLAN 20. In the example represented, this IP layer is also included in the APC 23, which constitutes a router. The APC, when it is present, could however play a simple role of layer 2 gateway. The transport layer protocol used is UDP (“User Datagram Protocol”). The UDP/IP packets then serve to transport information relevant to UMTS logical channels.

Thus, all the UMTS services relevant to layer 2 or more are available for a mobile terminal 18 accessing the system through the WLAN 20. In particular, specific UDP ports of the RNC 16 and of the terminal 18 are used for Dedicated Traffic CHannels (DTCH) or Dedicated Control CHannels (DCCH), the transport blocks of which are constructed and processed by an instance of the UMTS MAC-d protocol (“Medium Access Control-dedicated channels). Other UDP ports are used for the UMTS common channels, in particular for the downlink logical channels of BCCH type (“Broadcast Control CHannel”) and PCCH type (“Page Control CHannel”) and for the uplink and downlink logical channels of CCCH type (“Common Control CHannel”).

In the conventional IEEE 802.11 networks, there are two modes of control of access of the stations to the radio interface:
an open system mode, in which the stations are not authenticated: when a station picks up the IEEE 802.11 beacon transmitted by an AP, it transmits an authentication request to which the AP always responds positively before the station associates with the AP;
a secure mode in which the WLAN makes sure that the station holds a shared key in order to authenticate it and to allow it to associate.

In a scheme for integrating WLAN technology with an extended cellular system, having roaming subscribers, it is not realistic to share a secret key with all the subscribers of the cellular system that are able to access same through a specified WLAN. It is therefore natural to operate in open system at the WLAN level and to instruct the authentication of the terminals within the cellular system. However, this poses a certain number of difficulties.

Firstly, the UMTS operators proposing WLAN access typically desire to restrict access in IEEE 802.11 mode to potential customers only, that is to say to users having WLAN/UMTS dual-mode terminals. In particular, it is desirable to filter the IEEE 802.11 stations that are not UMTS compatible. However, when the WLAN operates in open system, any IEEE 802.11 station is capable of associating with an AP and obtaining an IP address with a server for dynamically allocating addresses, in general according to the DHCP protocol (“Dynamic Host Configuration Protocol”). Even if the UMTS-incompatible stations cannot go further and access the RNC, this results in inappropriate consumption of resources in the WLAN, in particular in terms of IP addressing.

Moreover, it will be relatively easy for a malicious individual to set up the UMTS protocol stack from the MAC layer in an IEEE 802.11 station. A station thus contrived could readily establish an RRC (“Radio Resource Control”) protocol connection with the RNC 16 and then direct repeated service requests to the core network 10.

Furthermore, it may happen that several zones served by IEEE 802.11 WLANs overlap. In such a case, it is desirable to be able to indicate to the terminal which access point(s) it ought to associate with.

It may also happen that one and the same WLAN 20 is interfaced with RNCs belonging to cellular systems of different operators. In this case, it is advisable to be able to point out to the terminal the RNC with which it should establish the RRC connection.

As the BCCH channel carrying the system information useful for exchanges with the UMTS infrastructure is a broadcasting channel, the destination IP address specified by the RNC in the datagrams transporting this BCCH information must be recognized by the terminals as being a broadcasting address. To do this, the “limited broadcast” IP address (1111 . . . 111) is typically used. However, the datagrams sent to this address are broadcast only in the immediate neighborhood of the transmitter. Consequently, if it turns out that the RNC does not belong to the same IP subnetwork as the APs, the RNC must rather use a broadcasting address inside the IP subnetwork relevant to the pertinent AP or APs so as to reach the radio interface, that is to say an IP address having the format: (<IP Subnet Prefix>111 . . . 111). However, the use of a broadcasting address in an IP subnetwork creates another problem. Given that the terminal 18 does not generally have a predefined IP address (it obtains one by means of a DHCP transaction), it does not know the IP subnetwork prefix (IP Subnet Prefix) so that it may be incapable of detecting the IP broadcasting address and hence of receiving the UMTS system information.

In 2001, the IEEE published the IEEE 802.1X standard which deals with control of access to local area networks by improving the authentication of terminals by means of a centralized server. This standard is applicable to all series 802 local area networks, in particular IEEE 802.3, IEEE 802.5 and IEEE 802.11. IEEE 802.1X authentication is based on a secret that the user shares with the server and not with the AP. The authentication messages comply with an EAP protocol (Extensible Authentication Protocol) and are transported in EAPOL frames (“EAP Over LAN”) over the radio interface and, for example, in RADIUS frames over the wire network.

An object of the present invention is to ease the control of access of dual-mode terminals to a cellular radio communication system through a wireless local area network, by limiting the incidence of the problems set forth hereinabove.

The invention thus proposes a method for controlling access to at least one cellular radio communication system through a wireless local area network, the cellular system having a radio access network comprising base stations and a controller to which said wireless network is linked. According to the invention, the method comprises the steps of:
authenticating a terminal with the cellular system through the radio access network;
allocating an authentication token to said terminal;
transmitting the allocated token from the controller to the terminal through the radio access network;
transmitting the allocated token and an identifier of the terminal from the controller to an authentication server accessible through said wireless network; and
authenticating the terminal with the wireless network by verifying that the terminal possesses the token transmitted to said authentication server.

A terminal is understood here to mean user equipment capable of communication with a cellular system, and also with a wireless local area network. Most of the current systems consider terminals formed by associating a Subscriber Identity Module (SIM) with a nonspecific apparatus of a subscription. The most representative case is then that where authentication involves the subscription, that is to say it brings the SIM into play. According to the procedures employed, authentication may possibly require the inputting of a secret code or of a password on the part of the user. It is also conceivable for authentication to involve the apparatus, or even jointly the apparatus and the SIM. Moreover, authentication could also involve terminals not possessing the concept of SIM.

Certain of the parameters essential for the access of a terminal through a WLAN are provided to this terminal only after authentication with the cellular system. WLAN authentication is not ensured exclusively at the level of the APs, but entails an authentication server accessible from the terminals via the WLAN and which receives the useful information from the controller. In the typical case where the WLAN is of IEEE 802.11 technology, this authentication can be performed in IEEE 802.1X mode.

In a simple embodiment, the authentication token is used as temporary password, the validity of which is coupled with a temporary user identifier. In another embodiment, the token is used as a temporary encryption key, with which the terminal encrypts a challenge proposed by the server. The authentication can also be mutual, that is to say not only does the server authenticate the terminal, but the terminal is capable also of authenticating the server, so as to avoid connecting up to a possibly malicious WLAN. The expression “authentication token” is thus understood to mean a set of authentication parameters (password, temporary encryption key, etc.) according to the authentication protocol used. Like the IEEE 802.1X norm, the invention is not limited as to the authentication protocols.

In an embodiment of the invention, the allocation of the authentication token is performed by the controller. In a certain number of cellular systems, such as UMTS, the initial exchange between the terminal and the controller (RNC) comprises the transmission by the terminal of a list of its features. In the case of a UMTS/WLAN dual-mode terminal, these features comprise the indication of this dual-mode nature. The allocation of the authentication token by the RNC can then be conditioned by the fact that the list transmitted by the terminal indicates such a dual-mode capability.

The controller advantageously transmits the authentication token to the terminal with identification information pertaining to the wireless local area network. This allows the terminal to ascertain the WLAN with which it is permitted to associate. This identification information can be selected by the controller on the basis of a location of the terminal in the radio access network.

This locating results for example from the radio access network's base station through which the terminal/controller dialog is established. Certain cellular systems, for example UMTS, offer terminal locating techniques operating with better accuracy than the granularity of a cell. One of these techniques relies on the use of GPS (“Global Positioning System”) in which case the locating accuracy is a few meters.

When the wireless local area network is linked to the controller through an IP network, the authentication token is advantageously transmitted to the terminal with information regarding addressing in this IP network. This addressing information may advantageously comprise:
an IP subnetwork broadcasting address employed by the controller to the broadcast system information through the WLAN;
an IP address of the authentication server in the IP network;
the IP address of the controller.

These various items of addressing information make it possible to obtain very great flexibility of implementation of the tight coupling between one or more cellular systems and one or more WLANs.

Another aspect of the present invention pertains to a controller for a radio access network of a cellular radio communication system, comprising:
means for interfacing with at least one base station of the cellular system;
means for interfacing with a wireless local area network;
means for allocating an authentication token to a terminal authenticated with the cellular system through the radio access network;
means for transmitting the allocated token to the terminal through the radio access network; and
means for transmitting the allocated token and an identifier of the terminal to an authentication server accessible through said wireless network, so that the terminal is authenticated with the wireless network by verification that the terminal possesses the token transmitted to said authentication server.

Other features and advantages of the present invention will become apparent in the following description of non-limiting exemplary embodiments, with reference to the appended drawings, in which:

FIG. 1, previously discussed, is an overall diagram of a UMTS system with which a WLAN has been integrated according to a tight coupling scheme;

FIG. 2, previously discussed, is a chart showing protocol stacks used for access to the UMTS system through the WLAN;

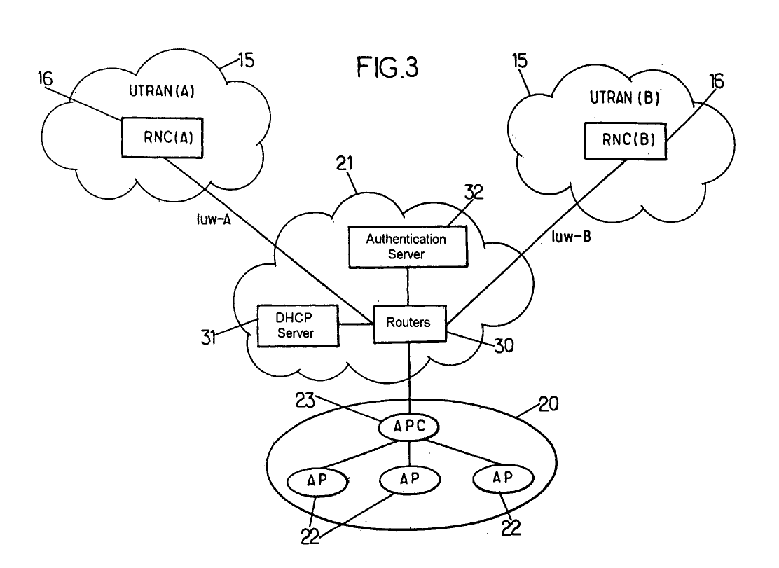

FIG. 3 is a schematic diagram showing various entities of an IP network that is used between the WLAN having one or more UMTS systems; and

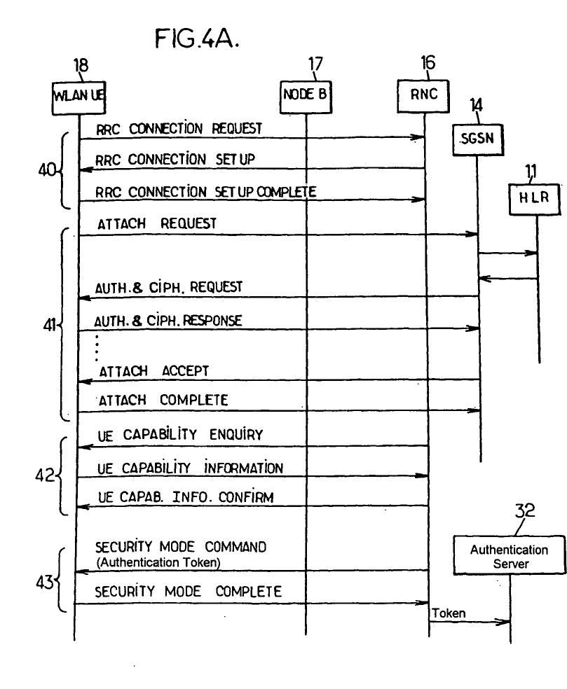

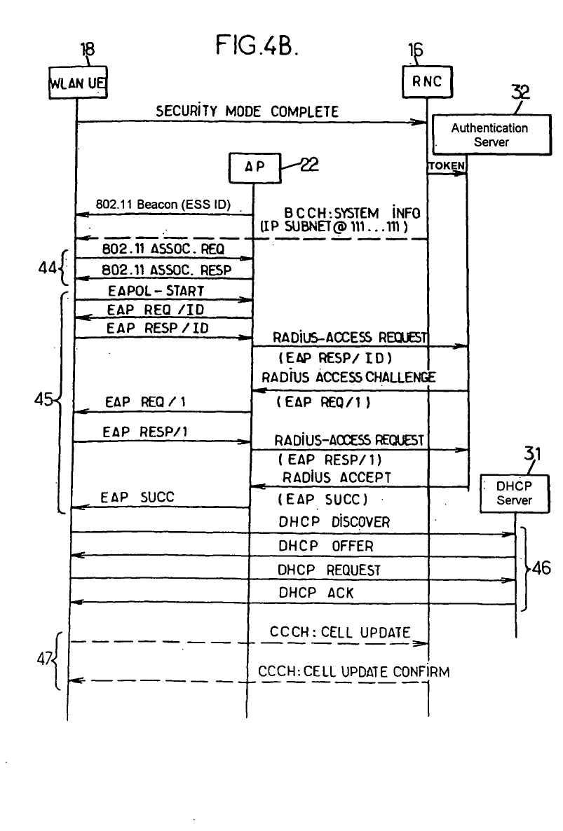

FIGS. 4A and 4B are charts illustrating examples of exchanges of messages occurring in accordance with the invention for controlling the access of a dual-mode terminal to the system illustrated by FIGS. 1 and 3.

FIG. 3 shows elements of the IP network 21 of FIG. 1, that are used in one embodiment of the invention. This network can comprise one or more routers 30 for conveying the IP datagrams. The WLAN 20 considered here corresponds to what is called an ESS (“Extended Service Set”) in the IEEE jargon, that is to say it extends over the zones of coverage of several APs 22 belonging to one and the same IP subnetwork. The APC 23 can also play an IP router role, as illustrated by FIG. 2.

In the example considered in FIG. 3, the IP network 21 allows the WLAN 20 to be linked up to two UTRANs 15, belonging for example to two different cellular operators A, B. There are then two RNCs 16 exhibiting the Iuw interface to the same WLAN.

The IP network 21 is provided with a DHCP server 31 to ensure dynamic allocation of IP addresses to IEEE 802.11 stations linked up with the APs 22. This dynamic allocation is performed in a known manner using the DHCP protocol described in RFC 2131 published in March 1997 by the IETF (“Internet Engineering Task Force”).

The IP network 21 is furthermore equipped with an authentication server 32 for performing the authentication of the IEEE 802.11 stations in accordance with the aforesaid IEEE 802.1X standard.

In accordance with the invention, the authentication of a dual-mode terminal 18 is performed in two stages to allow it to access the system through a WLAN; firstly with the cellular system 10 (HLR), then with the WLAN 20.

In the first phase, the terminal 18 conducts a dialogue with the cellular system through the access network 15, that is to say the exchanges with the RNC 16 pass via a node B 17, as illustrated by FIG. 4A.

A first step 40 can consist in the establishing of an RRC connection between the UE 18 and the RNC 16. The RRC protocol is described in detail in technical specification 3G TS 25.331, V3.3.0, “RCC Protocol Specification” published in June 2000 by the 3GPP. The procedure for establishing an RRC connection is described in section 8.1.3 of this specification.

Once the RRC connection has been established, the next step 41 comprises the authentication of the terminal 18 by the core network 10.

The way in which a UMTS terminal is authenticated is described in section 6.3 of technical specification 3G TS 33.102, V3.5.0, “Security Architecture”, published in July 2000 by the 3GPP. The SGSN 14 firstly interrogates the HLR 11 by indicating the identity (IMSI, “International Mobile Subscriber Identity”) of the terminal 18. The response of the HLR comprises one or more authentication vectors comprising several parameters useful for authentication and for exchanging encryption keys with the terminal. The SGSN uses a vector to test the terminal in an “Authentication_and_ciphering_request” message. The terminal then uses the subscription data that it holds and also an authentication algorithm to generate an “Authentication_and_ciphering_response” response that it returns to the SGSN. The latter then verifies the validity of the response with respect to the vector used to authenticate or otherwise the terminal 18.

This authentication procedure can be employed in various contexts for managing mobility involving the SGSN (see section 3.4.2 of Technical Specification 3G TS 24.008, V3.4.1, “Core Network Protocols—Stage 3”, published in July 2000 by the 3GPP). In the example represented in FIG. 4A, the context is that of a registering of the mobile terminal with the core network (“IMSI attach”).

In a known manner, the RNC 16 can obtain a list of features of the mobile terminal 18 that established the RRC connection. This is the object of step 42 indicated in FIG. 4A. The RNC interrogates the terminal in a “UE_capability_enquiry” message, to which the terminal responds by indicating its features in the “UE_capability_information” message, as described in sections 8.1.6 and 8.1.7 of the aforesaid 3G TS 25.331 specification.

The features of the terminal may also have been provided when establishing the RRC connection, in particular in the “Connection_setup_complete” message of step 40. In this case, step 42 is not necessary.

In the case which interests us here, the terminal 18 indicates its dual-mode capability in the “Connection_setup_complete” message or “UE_capability_information” message, so that the RNC 16 knows that it is an IEEE 802.11 compatible terminal.

As the RNC 16 knows moreover that it is linked to one or more WLANs 20 through the Iuw interface, it deals with the possibility that the terminal 18 is accessing the system through such a WLAN.

To do this, it allocates the dual-mode terminal 18 an authentication token which will allow the latter to authenticate itself with the WLAN 20. The authentication token consists of a password or another form of shared secret. The RNC transmits it on the one hand to the dual-mode terminal 18 and on the other hand to the authentication server 32. The authentication token has only temporary validity, fixed by the RNC.

The transmission of the token to the terminal 18 can in particular be performed in available fields of the “Security_mode_command” message of the RRC protocol (section 8.1.12 of the 3G TS 25.331 specification), to which the terminal responds through a “Security_mode_complete” message after having taken account of the security parameters stipulated by the RNC (exchange 43 in FIG. 4A).

The authentication token is transmitted to the server 32, with an identity of the terminal concerned, in one or more UDP/IP datagrams conveyed in the network 21. The identity of the terminal may be the IMSI or preferably the TMSI (“Temporary Mobile Subscriber Identity”) allocated to the terminal in the course of the registration procedure 41.

In a preferred embodiment of the invention, the message (“Security_mode_command” or the like) by which the RNC 16 provides the authentication token to the terminal 18 also comprises the following information elements:
ESS ID: identifier of the WLAN 20, allowing the terminal to ascertain whether it is permitted to register with a given WLAN;
IP Subnet Prefix: IP subnetwork prefix used in the WLAN, that is to say that all the terminals that associate therewith obtain IP addresses beginning with this prefix. This prefix makes it possible to know the IP address, of the form <IP Subnet Prefix>111 . . . 111, employed by the RNC 16 to broadcast the system information of the BCCH;
RNC IP @: IP address of the RNC 16 in the network 21, allowing the terminal to communicate with the RNC through the WLAN 20 according to the RRC connection established; and
Auth. Server IP @: IP address of the authentication server 32, so that the terminal proceeds with its authentication within the WLAN 20.

It is possible to supplement these information elements with the IP address of the DHCP server 31 to which the terminal addresses itself, to obtain a dynamically allocated IP address.

It should be noted that the RNC 16 can advantageously take account of the location of the terminal in the UTRAN 15 to select the above parameters. For example, it may designate a WLAN, via the ESS ID parameter, when the terminal is linked up with a node B 17 close to the zone of coverage of this WLAN.

It is also possible for the RNC 16 to be linked to several WLANs, in which case one or more parameters ESS ID are provided to the terminal as a function of its location. It is in particular possible to have several WLAN picocells in a single UMTS macrocell (umbrella cell). The node B can then be close to more than one WLAN. By virtue of the UMTS locating techniques, the RNC can ascertain the position of the mobile more accurately than the granularity of a macrocell.

FIG. 4B illustrates a sequence of messages that may occur to authorize access to the cellular system, through the WLAN 20, of a dual-mode terminal 18 that has received an authentication token.

The IEEE 802.11 radio beacon broadcast by an AP 22 includes the ESS ID identifier. When this beacon is picked up by the terminal that has received this ESS ID value with its authentication token, it can proceed with its association 44 with the AP and then instigate the procedure for authentication with the WLAN.

As indicated with dashed lines in FIG. 4B, the terminal is henceforth able to receive the RNC system information through the WLAN 20, given that it knows the IP address on which this WLAN is broadcasting the BCCH channel (<IP Subnet Prefix>111 . . . 111).

The authentication of the terminal with the WLAN 20 (step 45 of FIG. 4B) is performed according to the IEEE 802.1X process, that is to say through a dialog between the terminal 18 and the authentication server 32 according to the EAP protocol, the AP 22 ensuring the EAPOL/RADIUS format translations. The sequence of messages 45 is detailed in FIG. 4B.

When authentication is successful, the next step 46 is the DHCP transaction between the terminal 18 and the server 31 to provide the terminal with a dynamic IP address.

Once it has obtained this IP address, the terminal can conduct a dialog with the RNC 16 over a CCCH common channel transposed onto UDP/IP ports. In the example represented in FIG. 4B, this dialog 47 consists of an update of the terminal's assignment cell (“Cell update” procedure of section 8.3.1 of the 3G TS 25.331 specification).

It should be noted that the IP address of the authentication server 32 may not be transmitted explicitly to the terminal by the RNC if the user identity employed for the IEEE 802.1X authentication is coded in the IMSI-in-NAI format, that is to say in the form 0IMSI@realm. The reason for this is that the “realm” part identifies the authentication server implicitly. The terminal 18 can then address itself to a Domain Name Server (DNS) to recover the IP address of the server 32 before proceeding with its authentication.

The explicit transmission of this IP address by the RNC has the advantage of dispensing with this DNS transaction.

The authentication method described above is applicable in the general case where several UMTS operators can share the same WLAN 20, as in the configuration illustrated by FIG. 3.

The method is also applicable in the case where the same WLAN would be involved both in a tight coupling scheme and in a weak coupling scheme. The address of the authentication server, or the “realm” part of the IMSI-in-NAI identifier, then makes it possible to convey the authentication messages to the appropriate server (for example a local server in respect of tight coupling and a remote server in respect of weak coupling).

1. A method for controlling access to at least one cellular radio communication system through a wireless local area network, the cellular system having a radio access network comprising base stations and a controller to which said wireless network is linked, the method comprising the steps of:
authenticating a terminal with the cellular system through the radio access network;
allocating an authentication token to said terminal;
transmitting the allocated token from the controller to the terminal through the radio access network;
transmitting the allocated token and an identifier of the terminal from the controller to an authentication server accessible through said wireless network; and
authenticating the terminal with the wireless network by verifying that the terminal possesses the token transmitted to said authentication server.

2. The method as claimed in claim 1, wherein the allocation of the authentication token is performed by the controller.

3. The method as claimed in claim 2, wherein terminals adapted to the cellular system each transmit a respective list of features to the controller, and wherein the allocation of an authentication token to a terminal authenticated with the cellular system is performed on condition that the list transmitted by said terminal indicates a capability to access the wireless network.

4. The method as claimed in claim 1, wherein the authentication token is allocated temporarily to the terminal.

5. The method as claimed in claim 1, wherein the authentication token is transmitted to the terminal with identification information pertaining to the wireless local area network.

6. The method as claimed in claim 5, wherein the wireless local area network to which said identification information pertains is selected on the basis of a locating of the terminal in the radio access network.

7. The method as claimed in claim 1, wherein the wireless network is linked to the controller through an IP network.

8. The method as claimed in claim 7, wherein the authentication token is transmitted to the terminal with addressing information in said IP network.

9. The method as claimed in claim 8, wherein said addressing information comprises an IP subnetwork broadcasting address employed by the controller to broadcast system information through the wireless local area network.

10. The method as claimed in claim 8, wherein the authentication server is a server of said IP network, and wherein said addressing information comprises an IP address of the authentication server.

11. The method as claimed in claim 8, wherein said addressing information comprises an IP address of the controller.

12. A controller for a radio access network of a cellular radio communication system, comprising:
means for interfacing with at least one base station of the cellular system;
means for interfacing with a wireless local area network;
means for allocating an authentication token to a terminal authenticated with the cellular system through the radio access network;
means for transmitting the allocated token to the terminal through the radio access network; and
means for transmitting the allocated token and an identifier of the terminal to an authentication server accessible through said wireless network, so that the terminal is authenticated with the wireless network by verification that the terminal possesses the token transmitted to said authentication server.

13. The controller as claimed in claim 12, comprising means for receiving a respective list of features of a terminal adapted to the cellular system, and wherein the means for allocating an authentication token to a terminal authenticated with the cellular system are activated on condition that the list transmitted by said terminal indicates a capability to access the wireless network.

14. The controller as claimed in claim 12, wherein the authentication token is allocated temporarily to the terminal.

15. The controller as claimed in claim 12, wherein the authentication en is transmitted to the terminal with identification information pertaining to the wireless local area network.

16. The controller as claimed in claim 15, wherein the wireless local area network to which said identification information pertains is selected on the basis of a locating of the terminal in the radio access network.

17. The controller as claimed in claim 12, wherein the means for interfacing with the wireless local area network comprise an IP interface.

18. The controller as claimed in claim 17, wherein the authentication token is transmitted to the terminal with IP addressing information.

19. The controller as claimed in claim 18, wherein said addressing information comprises an IP subnetwork prefix employed to broadcast system information through the wireless local area network.

20. The controller as claimed in claim 18, wherein said addressing information comprises an IP address of the authentication server.

21. The controller as claimed in claim 18, wherein said addressing information comprises an IP address of the controller.
